(19) United States
(12) Patent Application Publication
(10) Pub. No.: US 2012/0276850 A1
(43) Pub. Date: Nov. 1, 2012

(54) ELECTRONIC APPARATUS AND COMMUNICATION CONTROL METHOD

(75) Inventor: Hideyuki Nakagawa, Fuchu-shi (JP)

(73) Assignee: KABUSHIKI KAISHA TOSHIBA, Tokyo (JP)

(21) Appl. No.: 13/404,670

(22) Filed: Feb. 24, 2012

(30) Foreign Application Priority Data
Apr. 27, 2011 (JP) 2011-099741

(51) Int. Cl. H04B 7/24

(52) U.S. Cl. 455/41.2

(57) ABSTRACT

According to one embodiment, an electronic apparatus includes a communication module, a connection establishing module, and a session control module. The communication module executes close proximity wireless transfer. The connection establishing module establishes a connection between the communication module and an external device. The session control module executes a first service when the connection has been established, and executes a second service when a threshold time has passed while the close proximity state is maintained after completion of the execution of the first service.

### CROSS-REFERENCE TO RELATED APPLICATIONS

This application is based upon and claims the benefit of priority from prior Japanese Patent Application No. 2011-099741, filed Apr. 27, 2011, the entire contents of which are incorporated herein by reference.

### FIELD

Embodiments described herein relate generally to an electronic apparatus which executes close proximity wireless transfer, and a communication control method which is applied to the electronic apparatus.

### BACKGROUND

In recent years, wireless communication such as Near Field Communication (NFC) has begun to be used in integrates circuit (IC) cards, mobile phones, etc. A user can easily execute communication for authentication, accounting, data exchange, etc., simply by performing an operation of holding the IC card or mobile phone over a reader/writer module of a host apparatus.

For example, there is proposed a technique in which identification information is read from a mobile terminal, which is held over a close proximity transfer module (reader/writer module) provided in a photo print apparatus. Since another wireless connection between the photo print apparatus and the mobile terminal is established by using the read identification information, photo data is delivered from the photo print apparatus to the mobile terminal. While a user is using the photo print apparatus, the identification information is read from the mobile terminal by using close proximity transfer. Thereby, after the user completes the use of the photo print apparatus, the user can receive photo data by other wireless communication, without staying there.

In the meantime, as regards the close proximity wireless transfer, there is a demand for a scheme in which a service is automatically started by simply bringing devices in close proximity. When the service is automatically started by simply bringing devices in close proximity, it is possible to realize, for example, such a function of synchronizing the data in a mobile phone and the backup of this data in a personal computer, by simply bringing the mobile phone in close proximity to the personal computer. Accordingly, in the close proximity wireless transfer method, if a close proximity state between devices is detected, a connection between the devices is automatically established.

However, when another service is to be executed after the completion of execution of a certain service, it is necessary to execute, for example, such an operation as separating devices and then bringing the devices in close proximity once again. Specifically, when the devices are left in close proximity, it is possible that no service is executed and resources of the devices are not effectively used, despite services being executable between the devices.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing the structure of an electronic apparatus according to an embodiment.

FIG. 2 shows an example of close proximity wireless transfer which is executed between the electronic apparatus of the embodiment and an external device.

FIG. 3 shows another example of close proximity wireless transfer which is executed between the electronic apparatus of the embodiment and an external device.

FIG. 4 shows an example of a software architecture for controlling close proximity wireless transfer, which is applied to the electronic apparatus of the embodiment.

FIG. 5 is an exemplary block diagram showing an example of the structure of a close proximity wireless transfer control program which is executed by the electronic apparatus of the embodiment.

FIG. 6 shows an example of a timing chart of close proximity wireless transfer which is executed between the electronic apparatus of the embodiment and an external device.

FIG. 7 shows another example of the timing chart of close proximity wireless transfer which is executed between the electronic apparatus of the embodiment and the external device.

FIG. 8 shows an example of a sequence at a time of starting a service session between the electronic apparatus of the embodiment and the external device.

FIG. 9 shows another example of the sequence at the time of starting the service session between the electronic apparatus of the embodiment and the external device.

FIG. 10 shows an example of a sequence at a time of starting a second service session between the electronic apparatus of the embodiment and the external device.

FIG. 11 is an exemplary flowchart illustrating an example of the procedure of a close proximity wireless transfer process which is executed by the electronic apparatus of the embodiment.

FIG. 12 is an exemplary flowchart illustrating another example of the procedure of the close proximity wireless transfer process which is executed by the electronic apparatus of the embodiment.

FIG. 13 is an exemplary flowchart illustrating an example of the procedure of a first service session control process which is executed by the electronic apparatus of the embodiment.

FIG. 14 is an exemplary flowchart illustrating an example of the procedure of a second service session control process which is executed by the electronic apparatus of the embodiment.

FIG. 15 is an exemplary flowchart illustrating still another example of the procedure of the close proximity wireless transfer process which is executed by the electronic apparatus of the embodiment.

FIG. 16 is an exemplary flowchart illustrating still another example of the procedure of the close proximity wireless transfer process which is executed by the electronic apparatus of the embodiment.

### DETAILED DESCRIPTION

Various embodiments will be described hereinafter with reference to the accompanying drawings.

In general, according to one embodiment, an electronic apparatus includes a communication module, a close proximity state detection module, a connection establishing module, and a session control module. The communication module executes close proximity wireless transfer. The close proximity state detection module detects that the communication module and an external device are in a close proximity state. The connection establishing module establishes a connection between the communication module and the external device when the close proximity state has been detected. The session control module executes a first service when the connection has been established, and executes a second service when a first threshold time has passed while the close proximity state is maintained after completion of the execution of the first service.

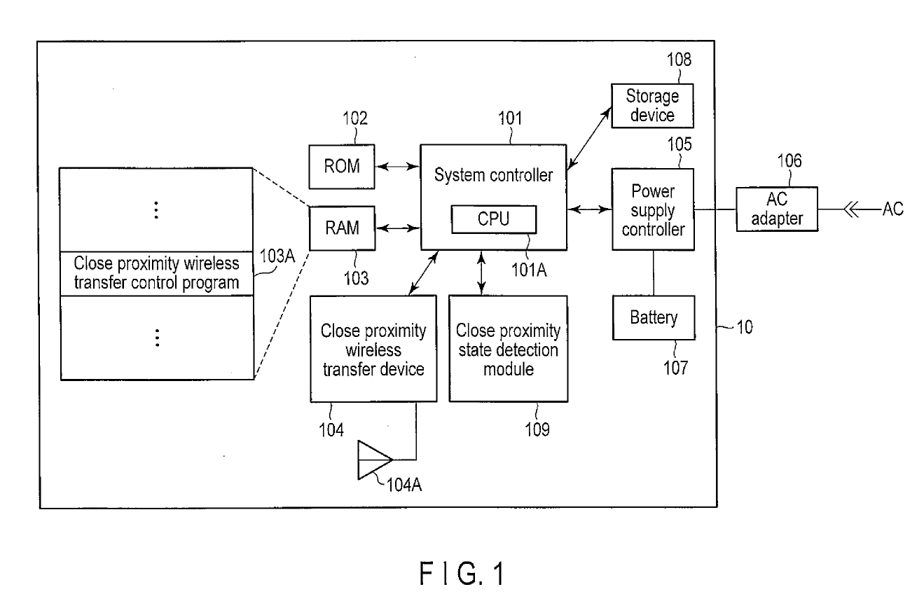

FIG. 1 shows the structure of an electronic apparatus according to an embodiment. The electronic apparatus is realized, for example, as a portable apparatus (e.g. a mobile phone, a PDA, an audio player, or an auxiliary storage medium), a personal computer, or a consumer apparatus (e.g. a TV or a video recorder). The electronic apparatus includes a communication module which executes close proximity wireless transfer. The electronic apparatus executes close proximity wireless transfer with some other device (external device) having a close proximity wireless transfer function in a peer-to-peer mode by establishing a wireless connection to the external device.

This electronic apparatus 10 includes a system controller 101, a ROM 102, a RAM 103, a close proximity wireless transfer device 104, a power supply controller 105, an AC adapter 106, a battery 107, a storage device 108, and a close proximity state detection module 109.

The system controller 101 controls the operations of the respective components in the electronic apparatus 10. The system controller 101 includes a CPU 101A, and is connected to the ROM 102, RAM 103, close proximity wireless transfer device 104, power supply controller 105, storage device 108, and close proximity state detection module 109.

The CPU 101A is a processor which loads instructions and data, which are stored in the ROM 102, into the RAM 103, and executes required processes. In the RAM 103, a close proximity wireless transfer control program 103A for controlling close proximity wireless transfer is loaded. The CPU 101A executes the close proximity wireless transfer control program 103A loaded in the RAM 103, thereby controlling the close proximity wireless transfer device 104 and close proximity state detection module 109.

The close proximity wireless transfer device 104 is a communication module which executes close proximity wireless transfer. The close proximity wireless transfer device 104 establishes a wireless connection to some other device (external device) having a close proximity wireless transfer function, which is present within a predetermined distance from the close proximity wireless transfer device 104, and then starts transmission of data such as files. The close proximity wireless transfer between the close proximity wireless transfer device 104 and the external device is executed in a peer-to-peer mode. The range of communication is, e.g. three centimeters.

The close proximity state detection module 109 detects whether the close proximity wireless transfer device 104 and the external device are in a close proximity state. For example, when the close proximity wireless transfer device 104 and the external device are in close proximity, that is, when the distance between the close proximity wireless transfer device 104 and the external device is decreased to the range of communication (e.g. three centimeters) or less, the close proximity state detection module 109 detects that the close proximity wireless transfer device 104 and the external device are in a close proximity state. In the meantime, based on connection information which is output by the close proximity wireless transfer device 104, the close proximity state detection module 109 may detect whether the close proximity wireless transfer device 104 and the external device are in a close proximity state.

When the close proximity wireless transfer device 104 and the external device are brought close to each other within the range of communication, a wireless connection is established between the close proximity wireless transfer device 104 and the external device. Then, for example, the external device accesses a predetermined storage area in the storage device 108, and transmission of data by read of a data file from the predetermined storage area or write of a data file in the predetermined storage area is executed between the close proximity wireless transfer device 104 and the external device.

In the close proximity wireless transfer, an induction electric field is used. As a close proximity wireless transfer method, TransferJet® or Felica®, for instance, can be used. TransferJet is a close proximity wireless transfer method which uses UWB, and realizes high-speed data transfer.

The close proximity wireless transfer device 104 is connected to an antenna 104A. The antenna 104A is an electrode called “coupler”, and executes data transmission/reception to/from the external device by a wireless signal using an induction electric field. When the external device comes near within the range of communication (e.g. three centimeters) from the antenna 104A, the antennas (couplers) of the close proximity wireless transfer device 104 and the external device are coupled by the induction electric field, and thereby wireless communication between the close proximity wireless transfer device 104 and the external device is enabled. In the meantime, the close proximity wireless transfer device 104 and the antenna 104A may be realized as a single module.

The power supply controller 105 supplies power to the respective components in the electronic apparatus 10 by using power which is supplied from the outside via the AC adapter 106 or power which is supplied from the battery 107. In other words, the electronic apparatus 10 is driven by an external power supply such as an AC commercial power supply, or by the battery 107. The AC adapter 106 may be provided within the electronic apparatus 10.

The close proximity wireless transfer device 104 (electronic apparatus 10) is controlled to operate as either an initiator or a responder. When the close proximity wireless transfer device 104 operates as the initiator, the close proximity wireless transfer device 104 requests a connection to the external device (responder) which is in close proximity. Thus, the close proximity wireless transfer device 104 transmits to the external device a connection request signal for requesting the connection, and the external device transmits to the close proximity wireless transfer device 104 a connection accept signal in response to the connection request signal. Thereby, a connection between the close proximity wireless transfer device 104 and the external device is established.

In addition, when the close proximity wireless transfer device 104 operates as the responder, a connection to the close proximity wireless transfer device 104 is requested by the external device (initiator) which is in close proximity. Thus, the external device transmits to the close proximity wireless transfer device 104 a connection request signal for requesting the connection, and the close proximity wireless transfer device 104 transmits to the external device a connection accept signal in response to the connection request signal. Thereby, a connection between the close proximity wireless transfer device 104 and the external device is established.

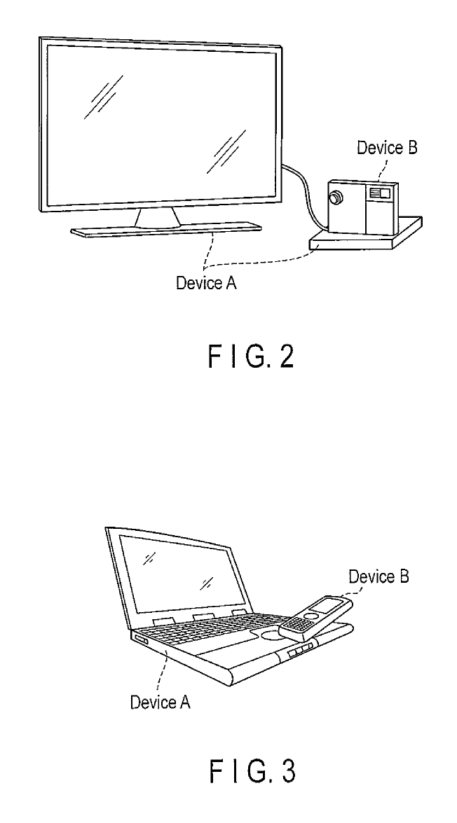

FIGS. 2 and 3 illustrate close proximity wireless transfer which is executed between two devices. A user performs an operation (“touch operation”) of bringing, for example, a device B in close proximity to a device A. Thereby, data transfer between the devices A and B can be started. The execution of the data transfer between the devices A and B is triggered when the devices A and B have come in close proximity. The electronic apparatus 10 can function as either the device A or device B.

In the example illustrated in FIG. 2, the case is assumed in which the device A is composed of a TV and a pad having a close proximity wireless transfer function, and the device B is composed of a digital still camera (DSC) having a close proximity wireless transfer function. The TV and the pad are connected by a legacy interface such as a USB. In this example, the close proximity wireless transfer is used to send photo data from the DSC to the TV via the pad, thereby to view photos taken by using the DSC, for example, in a trip. The user selects a photo on the DSC, which is to be displayed on the TV, and touches the DSC to the pad that is connected to the TV. By this touch operation, the photo, which has been selected on the DSC, is sent to the TV via the pad, and the photo is displayed on the screen in a format of, e.g. a slide show. After the display of the photo is completed, the user separates the DSC from the pad.

In the example illustrated in FIG. 3, the case is assumed in which the device A is composed of a notebook-type personal computer (PC) having a close proximity wireless transfer function, and the device B is composed of a smartphone having a close proximity wireless transfer function. In this example, the close proximity wireless transfer is used to send content data from the smartphone to the PC, thereby to back up the content data which was downloaded in the smartphone. The user selects content on the smartphone, which is to be stored in the PC, and touches the smartphone to a close proximity wireless transfer module of the PC. By this touch operation, the content, which has been selected on the smartphone, is sent to the PC and stored in, e.g. a storage device in the PC. After all contents selected on the smartphone have been stored in the PC, the user separates the smartphone from the PC.

By the touch operation of bringing the two devices in close proximity, as described above, data exchange using the close proximity wireless transfer is executed between the devices. After the completion of the execution, if the user is to further execute some other service, the user needs to perform an operation (re-touch operation) of separating the devices and touching the devices once again. Thus, when the devices are left in close proximity, it is possible that no further service can be executed, despite services being executable between the devices, and resources of the devices cannot effectively be used. To cope with this problem, in the electronic apparatus 10 of the present embodiment, when the state of close proximity to the external device is maintained (i.e. the electronic apparatus 10 and the external device are left in close proximity) after a first service session between the electronic apparatus 10 and the external device has been completed, a second service session is started. For example, as regards the TV and DSC shown in FIG. 2, when a predetermined period has passed since the end of the slide show (first service), while the close proximity state between the TV and DSC is maintained, the contents of the data stored in the memory of the DSC (e.g. the directory, files, etc. stored in the memory) is displayed on the screen of the TV by starting a storage service (second service). In addition, for example, as regards the PC and smartphone shown in FIG. 3, when a predetermined period has passed since the end of the storage of content (first service), while the close proximity state between the PC and smartphone is maintained, the smartphone can be used as an external modem by starting a network service (second service). Thereby, the resources of the devices, which are kept in close proximity, can effectively be used, and the convenience for the user can be improved.

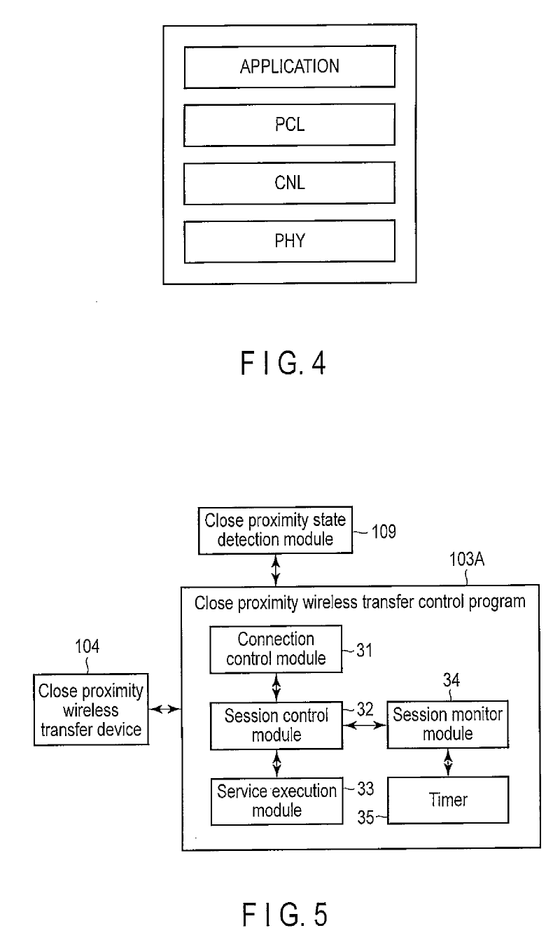

Next, FIG. 4 shows a software architecture for controlling close proximity wireless transfer which is executed with use of the close proximity wireless transfer device 104.

The software architecture of FIG. 4 shows a hierarchical structure of a protocol stack for controlling close proximity wireless transfer. The protocol stack includes a physical layer (PHY), a connection layer (CNL), a protocol conversion layer (PCL), and an application layer. For example, the connection layer (CNL), the protocol conversion layer (PCL) and the application layer may be realized by the wireless transfer control program 103A.

The physical layer (PHY) is a layer which controls physical data transfer, and corresponds to a physical layer in an OSI reference model. A part or all of the functions of the physical layer (PHY) may also be realized by using hardware in the close proximity wireless transfer device 104.

The physical layer (PHY) converts data from the connection layer (CNL) to a wireless signal. The connection layer (CNL) corresponds to a data link layer through a transport layer in the OSI reference model. The connection layer executes a process of establishing a connection (CNL connection) between the close proximity wireless transfer device 104 and the external device, which are set in a close proximity state, and transmitting data.

The protocol conversion layer (PCL) corresponds to a session layer in the OSI reference model, and is positioned between the application layer and the connection layer (CNL) for controlling establishment and release of the connection between the devices A and B. The protocol conversion layer (PCL) executes a framework of management of each application (communication program) in the application layer, and executes session control. The session corresponds to a communication path between the application layer of the electronic apparatus 10 and the application layer of the external device.

The application layer includes various communication programs (applications) corresponding to various application protocols (e.g. SCSI, OBEX, and other general-purpose protocols). The close proximity wireless transfer control program 103A of the embodiment has a function corresponding to the connection layer (CNL). In the meantime, the transfer control program 103A may have functions corresponding to the protocol conversion layer (PCL) and application layer.

Next, FIG. 5 shows the structure of the close proximity wireless transfer control program 103A. The transfer control program 103A includes a session execution function for executing a service session, and a session control function for controlling the execution of a plurality of sessions. The session execution function is a function for starting (establishing) a session, executing the session, and terminating (releasing) the session. The session control function is a control function for starting, for example, a second session when a state of close proximity to an external device is maintained after the completion of a first session with the external device.

The transfer control program 103A includes a connection control module 31, a session control module 32, a service execution module 33, a session monitor module 34, and a timer 35.

The connection control module 31 controls a connection (CNL connection) between the close proximity wireless transfer device 104 and the external device (a communication module provided in the external device).

Specifically, the connection control module 31, when operating as an initiator, transmits a connection request signal for requesting a connection to the external device which is in close proximity. Then, by having received from the external device a connection response signal in response to the transmitted connection request signal, the connection control module 31 establishes a connection between the close proximity wireless transfer device 104 and the external device.

In addition, the connection control module 31, when operating as a responder, receives a connection request signal which has been transmitted by the external device which is in close proximity. Then, by having transmitted to the external device a connection response signal in response to the received connection request signal, the connection control module 31 establishes a connection between the close proximity wireless transfer device 104 and the external device.

The connection control module 31 then notifies the session control module 32 of the establishment of the connection between the close proximity wireless transfer device 104 and the external device.

In response to the notification by the connection control module 31, the session control module 32 controls a session for executing a service. The session control module 32 determines a service which is to be executed, by a negotiation with the external device, and then establishes the session. In addition, after the execution of the service is completed, the session control module 32 releases the session.

Specifically, after the connection to the external device is established, the session control module 32 controls a first service session for executing a first service.

To begin with, the session control module 32 transmits to the external device a first service session request signal requesting the establishment (start) of the first service session. The first service session request signal includes information indicative of the first service which is executed in the first service session. The first service is a service for, for example, data transfer.

When the session control module 32 has received from the external device a first service session accept signal (i.e. a first service session accept signal in response to the transmitted first service session request signal) which accepts the establishment of the first service session, the session control module 32 establishes the first service session. Then, the session control module 32 notifies the service execution module 33 that the first service session for executing the first service has been established. On the other hand, when the session control module 32 has received from the external device a first service session refuse signal which refuses the establishment of the first service session, the session control module 32 does not establish the first service session. For example, if the first service, which is designated in the first service session request signal, is an executable service, the external device transmits the first service session accept signal to the close proximity wireless transfer device 104 (electronic apparatus 10). If the first service, which is designated in the first service session request signal, is not an executable service, the external device transmits the first service session refuse signal to the close proximity wireless transfer device 104. Thus, when the first service is a service which can be executed by both the electronic apparatus 10 and the external device, the first service session is established between the electronic apparatus 10 and the external device.

The service execution module 33 executes the first service, in response to the notification of the establishment of the first service session by the session control module 32. Specifically, according to the content of the first service, the service execution module 33 executes various data exchange, etc., using close proximity wireless transfer between the electronic apparatus 10 and the external device. Then, when the execution of the first service has been completed, the session execution module 33 notifies the session control module 32 of the completion of execution of the first service.

In response to the notification of the completion of execution of the first service by the service execution module 33, the session control module 32 terminates the first service session. Specifically, the session control module 32 releases the first service session which has been established between the electronic apparatus 10 and the external device.

Incidentally, the session control module 32 may receive from the external device a first service session request signal requesting the establishment of a first service session. The first service session request signal, as described above, includes information indicative of a first service which is to be executed in the first service session. Based on the information indicative of the first service, the session control module 32 determines whether the first service is executable. If the first service is executable, the session control module 32 establishes the first service session by transmitting to the external device a first service session accept signal accepting the establishment of the first service session. If the first service is not executable, the session control module 32 does not establish the first service session by transmitting to the external device a first service session refuse signal refusing the start of the first service session.

The session monitor module 34 monitors the establishment/release of the session (i.e. the start/end of the session) by the session control module 32. For example, the session monitor module 34 detects that the first service session has been released. The session monitor module 34 also detects, as the release (end) of the first service session, the fact that the first service session has not been established since the service, which is designated in the first service session request signal, is not executable in the device which has received the first service session request signal. Specifically, the session monitor module 34 detects the termination of the first service session control process for executing the first service (hereinafter also referred to as “the termination of the first service session”), regardless of the success/failure of the establishment of the first service session.

The session monitor module 34 executes control to start a second service session for executing a second service, when the close proximity state between the close proximity wireless transfer device 104 (electronic apparatus 10) and the external device is maintained for more than a threshold time after the termination of the first service session (i.e. the completion of execution of the first service) is detected. In addition, the session monitor module 34 may execute control to start a second service session for executing a second service, when the connection between the close proximity wireless transfer device 104 (electronic apparatus 10) and the external device is maintained for more than a threshold time after the termination of the first service session is detected.

Specifically, in response to the detection of the termination of the first service session, the session monitor module 34 requests the timer 35 to measure an elapsed time. The timer 35 measures a relative time passage from a certain time point. Specifically, the timer 35 measures an elapsed time from the termination of the first service session. When the elapsed time measured by the timer 35 exceeds the threshold time, the session monitor module 34 determines a service which is to be executed as the second service. Then, the session monitor module 34 requests the session control module 32 to start the second service session for executing the second service. In addition, in response to the fact that the start of the second service session has been requested (i.e. the second service session has been started), the session monitor module 34 requests the timer 35 to stop measuring the elapsed time. The second service is a constant service (always-connected service) such as a storage service or a network service. The storage service enables one device to use a memory (storage device) of the other device as a storage. The network service is a service for enabling one device to use the other device as an external modem.

When the close proximity state detection module 109 has detected that the close proximity state between the close proximity wireless transfer device 104 and the external device has been released, the connection between the close proximity wireless transfer device 104 and the external device is released. Thus, the session monitor module 34 requests the timer 35 to stop measuring the elapsed time, and does not request the session control module 32 to start the second service session. Accordingly, the process for executing the second service is not executed. Incidentally, the session monitor module 34 may request the timer 35 to stop measuring the elapsed time, when the connection between the close proximity wireless transfer device 104 and the external device has been released.

Besides, in response to the request for starting the second service session by the session monitor module 34, the session control module 32 transmits to the external device a second service session request signal requesting the establishment of the second service session. The second service session request signal includes information indicative of the second service which is to be executed in the second service session.

Then, when the session control module 32 has received from the external device a second service session accept signal which accepts the establishment of the second service session, the session control module 32 establishes the second service session. The session control module 32 then notifies the service execution module 33 that the second service session for executing the second service has been established. On the other hand, when the session control module 32 has received from the external device a second service session refuse signal which refuses the establishment of the second service session, the session control module 32 does not establish the second service session. For example, if the second service, which is designated in the second service session request signal, is an executable service, the external device transmits the second service session accept signal to the close proximity wireless transfer device 104. If the second service, which is designated in the second service session request signal, is not an executable service, the external device transmits the second service session refuse signal to the close proximity wireless transfer device 104. Thus, when the second service is a service which can be executed by both the electronic apparatus 10 and the external device, the second service session is established between the electronic apparatus 10 and the external device.

The service execution module 33 executes the second service, in response to the notification of the establishment of the second service session by the session control module 32. Specifically, according to the content of the second service, the service execution module 33 executes various data transfer, etc., using close proximity wireless transfer between the electronic apparatus 10 and the external device. Then, when the execution of the second service has been completed, the session execution module 33 notifies the session control module 32 of the completion of execution of the second service.

In response to the notification of the completion of execution of the second service by the service execution module 33, the session control module 32 terminates the second service session. Specifically, the session control module 32 releases the second service session which has been established between the electronic apparatus 10 and the external device.

Incidentally, the session control module 32 may receive from the external device a second service session request signal requesting the establishment of a second service session. The second service session request signal, as described above, includes information indicative of a second service which is to be executed in the second service. In addition, for example, the second service, which is designated in the second service session request signal transmitted form the close proximity wireless transfer device 104 (electronic apparatus 10) to the external device, and the second service, which is designated in the second service session request signal transmitted from the external device to the close proximity wireless transfer device 104, are different kinds of services. Based on the information indicative of the second service, the session control module 32 determines whether the second service is executable. If the second service is executable, the session control module 32 transmits to the external device a second service session accept signal accepting the establishment of the second service session, thereby establishing the second service session. In addition, the session monitor module 34 requests the timer 35 to stop measuring the elapsed time. If the second service is not executable, the session control module 32 does not establish the second service session by transmitting to the external device a second service session refuse signal refusing the start of the second service session.

Thus, the session monitor module 34 and session control module 32 may function in the following manner. For example, a second service session request signal is transmitted to the external device, and a second service session refusal signal is received from the external device, resulting in a failure to establish the second service session. Thereafter, a second service session request signal is received from the external device, and a second service session accept signal is transmitted to the external device, and thereby the second service session is successfully established.

As described above, the request for establishing the second service session is issued to the external device, when the elapsed time from the termination of the first service session, which is measured by the timer 35, has exceeded the threshold time. Thus, for example, different times may be set for a first threshold time which is used in the electronic apparatus 10, and for a second threshold time which is used in the external device. Thereby, the timing at which the electronic apparatus 10 requests the external device to start the second service session can be different from the timing at which the external device requests the electronic apparatus 10 to start the second service session.

For example, assume that the second threshold time is longer than the first threshold time. In this case, when the elapsed time from the termination of the first service session has exceeded the first threshold time, the electronic apparatus 10 (session control module 32) requests the external device to establish the second service session. Then, when the second service session has been successfully established, the second service is executed between the electronic apparatus 10 and the external device. In addition, when the establishment of this second service session failed and the elapsed time from the termination of the first service session has exceeded the second threshold time, the external device requests the electronic apparatus 10 to establish the second service session. Thus, by setting different times for the first threshold time and the second threshold time, the probability of establishment of the second service session (i.e. the probability of execution of the second service) can be increased. The first threshold time and the second threshold time are set, for example, at a time of the first service session. Besides, the first threshold time and the second threshold time may be set, when the devices are produced by the vendor.

By the above-described structure, such control can be executed that the second service session is started when the close proximity state between the electronic apparatus 10 (close proximity wireless transfer device 104) and the external device is maintained for more than the threshold time after the termination of the first service session. Thereby, for example, when the electronic apparatus 10 and the external device are left in close proximity after the completion of execution of the first service, the second service can be executed. Therefore, the convenience for the user can be enhanced.

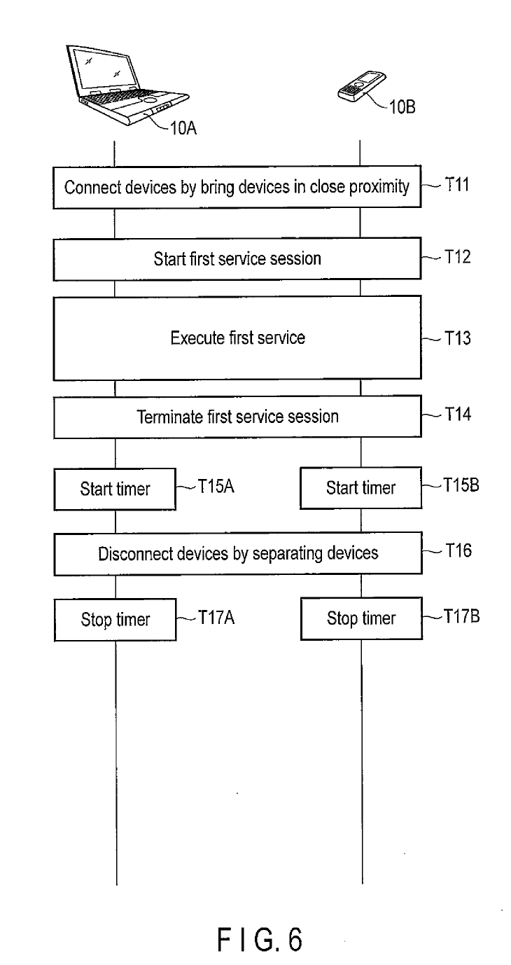

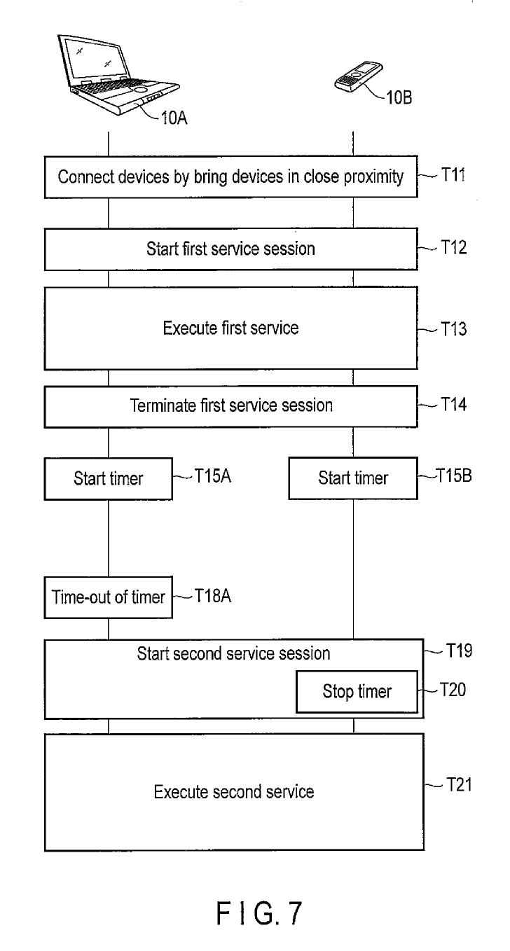

FIGS. 6 and 7 illustrate examples of a timing chart of a close proximity wireless transfer process which is executed by an electronic apparatus 10A and an external device 10B. The electronic apparatus 10A is, for example, a notebook-type personal computer. The external device 10B is, for example, a smartphone. Each of the electronic apparatus 10A and external device 10B has a close proximity wireless transfer function for executing close proximity wireless transfer, as illustrated in FIGS. 1 and 5. In the example shown in FIG. 6, it is assumed that the user performs an operation of separating the devices after the completion of execution of a first service. On the other hand, in the example shown in FIG. 7, it is assumed that the user leaves the devices in close proximity after the completion of execution of the first service.

To start with, in the example shown in FIG. 6, the user brings the electronic apparatus 10A and external device 10B in close proximity, thereby establishing a connection between the electronic apparatus 10A and external device 10B (T11). Then, a first service session for starting a first service is started between the electronic apparatus 10A and external device 10B (i.e. a session is established) (T12).

Then, the first service is executed between the electronic apparatus 10A and external device 10B (T13). The first service is, for example, a service for data exchange for transmitting data, which is stored in the external device 10B, to the electronic apparatus 10. When the execution of the first service has been completed, the first service session, which has been established between the electronic apparatus 10A and external device 10B, is terminated (i.e. the established session is released) (T14). In response to the termination of the session, the electronic apparatus 10A starts the timer 35 (T15A), and the external device 10B starts the timer (T15B). The timer 35 of the electronic apparatus 10A and the timer of the external device 10B measure elapsed times from the termination of the first service session.

Then, when the electronic apparatus 10A and external device 10B have been separated by the user, the connection between the electronic apparatus 10A and external device 10B is disconnected (released) (T16). In response to the release of the connection between the electronic apparatus 10A and external device 10B, the electronic apparatus 10A stops the timer 35 (T17A), and the external device 10B stops the timer (T17B).

In the above-described process, since the close proximity state between the electronic apparatus 10A and external device 10B is released before the elapsed time measured by the timer 35 exceeds a first threshold, a second service is not executed.

In the example shown in FIG. 7, like the example of FIG. 6, the timer is started after the completion of the first service (T11 to T15). However, since the electronic apparatus 10A and external device 10B are left in the close proximity state after the completion of the first service, the timer 35 of the electronic apparatus 10, for example, times out (T18A). Specifically, the elapsed time measured by the timer 35 of the electronic apparatus 10 exceeds the first threshold time.

In response to the time-out of the timer, the electronic apparatus 10A and external device 10B start a second service session (T19). In addition, the timer of the external device 10B is stopped (T20). Then, a second service is executed between the electronic apparatus 10A and external device 10B (T21). The second service is a constant service (always-connected service) such as a storage service or a network service. This aims at preventing repeated execution of many services, such as a third service and a fourth service, by the execution of a service that is not a constant service, in the case of which a session is terminated after a predetermined process is completed. Thus, the second service is, for example, a service which is completed by the user's action (e.g. an operation of separating the electronic apparatus 10A and external device 10B, or an operation of stopping a service on an application program).

In the above-described process, the second service is executed between the electronic apparatus 10A and external device 10B, in response to the fact that the time measured by the timer 35 has exceeded the first threshold time after the completion of execution of the first service. Specifically, the fact that the user leaves the electronic apparatus 10A and external device 10B in the close proximity state after the completion of execution of the first service is regarded as one of actions (operations) by the user and is used as a trigger to start the second service. Thus, simply by performing only once the touch operation of bringing the electronic apparatus 10A and external device 10B in close proximity, the user can execute two services. Therefore, the convenience for the user can be enhanced.

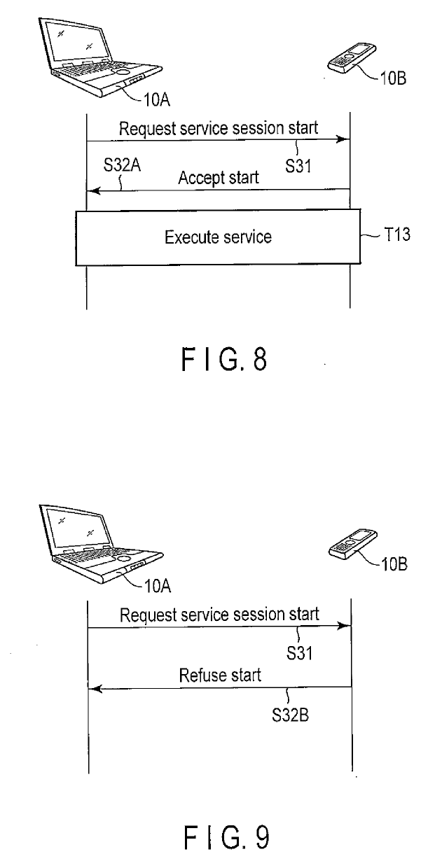

FIGS. 8 and 9 illustrate examples of a sequence at a time of starting a service session between the electronic apparatus 10A and external device 10B.

In the example shown in FIG. 8, to start with, the electronic apparatus 10A requests the external device 10B to start a service session (S31). If the requested service is an executable service, the external device 10B accepts the start of the service session (S32A). Then, the service is executed between the electronic apparatus 10A and external device 10B (T13).

In the example shown in FIG. 9, the electronic apparatus 10A requests the external device 10B to start a service session (S31). If the requested service is not an executable service, the external device 10B refuses the start of the service session (S32B). Accordingly, no service is executed between the electronic apparatus 10A and external device 10B.

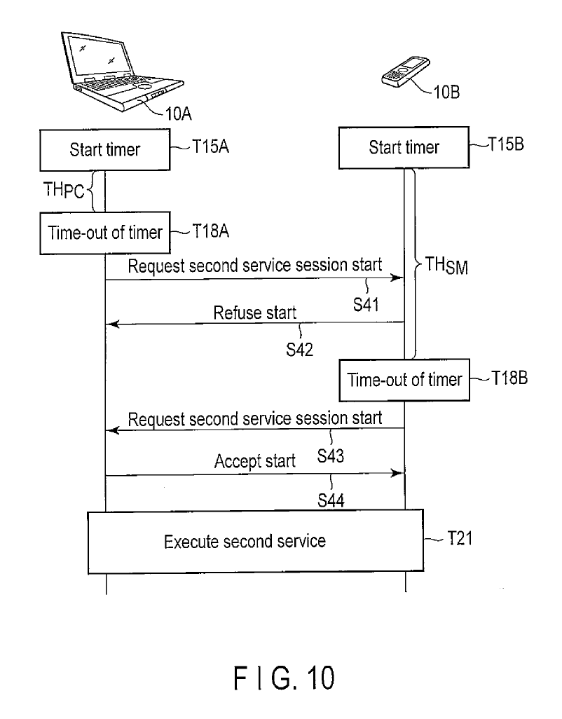

As has been described above, even when the start of a service session is requested by one device, if this service is not executable in the other device, the service is not executed. Thus, in the present embodiment, as shown in FIG. 10, different times are set for a threshold time TH_{PC} at which the timer provided in the electronic apparatus 10A times out, and for a threshold time TH_{SM} at which the timer provided in the external device 10B times out. For example, the threshold time TH_{PC} of the electronic apparatus 10A, which has requested the start of the first service session (the latest service session), is set to be shorter than the threshold time TH_{SM} of the external device 10B which has been requested to start the first service session. Since the threshold time TH_{PC} and the threshold time TH_{SM} are different, even if a request for starting a service session by one device is refused, another request for starting the service session can be issued by the other device. Therefore, the probability of execution of the service can be increased.

In the example shown in FIG. 10, it is assumed that the close proximity state between the electronic apparatus 10A and external device 10B is maintained after the termination of the first service session. Thus, the electronic apparatus 10A starts the timer 35 (T15A) and the external device 10B starts the timer (T15B). When the threshold time TH_{PC} has passed since the start of the timer, the timer 35 of the electronic apparatus 10A times out (T18A). In response to the time-out of the timer 35, the electronic apparatus 10A requests the external device 10B to start a second service session (S41). Since the second service requested by the electronic apparatus 10A is not an executable service, the external device 10B refuses the start of the session (S42).

Then, when the threshold time TH_{SM} has passed since the start of the timer, the timer of the external device times out (T18B). In response to the time-out of the timer, the external device 10B requests the electronic apparatus 10A to start the second service session (S43). Since the second service requested by the external device 10B is an executable service, the electronic apparatus 10A accepts the start of the session (S44). Then, the second service is executed between the electronic apparatus 10A and external device 10B (T21).

By the above-described communication sequence, even if the request for starting the second service session by the electronic apparatus 10A is refused, a further request for starting the second service session can be issued by the external device 10B. Therefore, the probability of execution of the service can be increased.

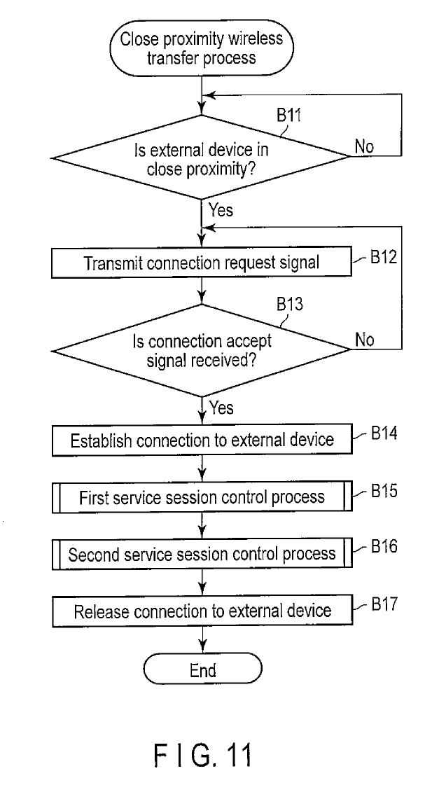

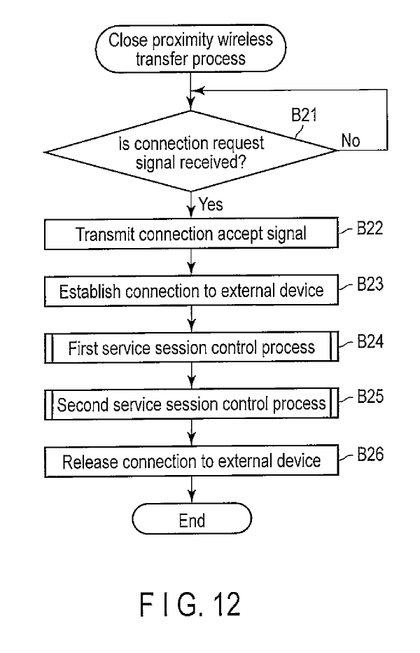

Next, referring to flowcharts of FIGS. 11 and 12, a description is given of examples of the close proximity wireless transfer process which is executed by the electronic apparatus 10A.

The flowchart of FIG. 11 illustrates an example of the procedure of the close proximity wireless transfer process at a time when the electronic apparatus 10A operates as an initiator which requests a connection to the external device 10B that is in close proximity.

To start with, the close proximity state detection module 109 determines whether the external device 10B is in close proximity (block B11). If the external device 10B is not in close proximity (NO in block B11), the process returns to block B11, and determines once again whether the external device 10B is in close proximity. On the other hand, if the external device 10B is in close proximity (YES in block B11), the connection control module 31 transmits a connection request signal for requesting a connection to the external device 10B via the close proximity wireless transfer device 104 (block B12).

Then, the connection control module 31 determines whether a connection accept signal which accepts a connection has been received from the external device 10B via the close proximity wireless transfer device 104 (block B13). If the connection accept signal has not been received (e.g. if a connection refuse signal which refuses a connection has been received, or if a connection accept signal has not been received even after the passing of a predetermined period) (NO in block B13), the process returns to block B12, and the connection control module 31 transmits the connection request signal once again. When a connection accept signal is not received even if the connection request signal has been transmitted a predetermined number of times, the process may be terminated.

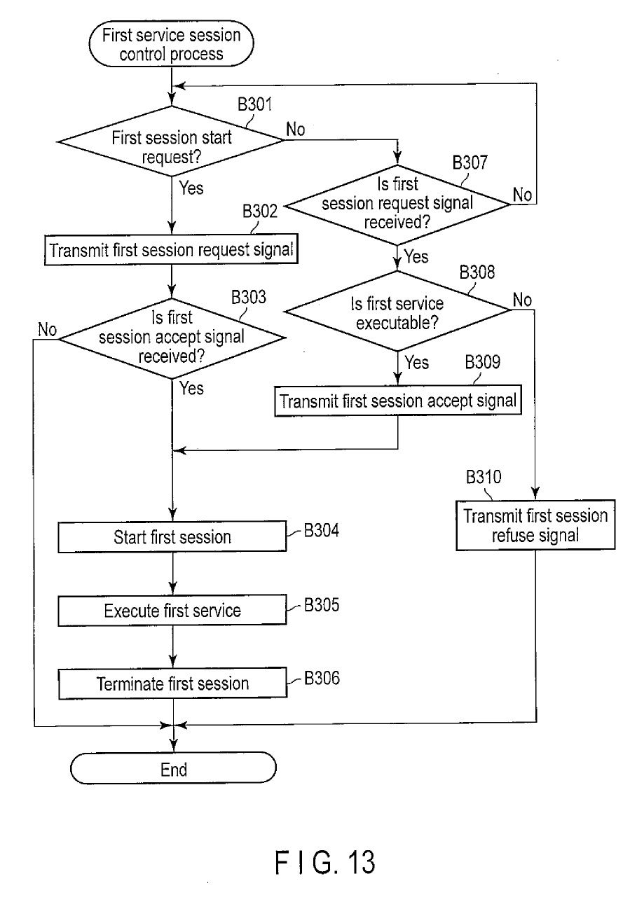

On the other hand, if the connection accept signal has been received (YES in block B13), the connection control module 31 establishes a connection (CNL connection) between the close proximity wireless transfer device 104 and the external device 10B (block B14). Then, the session control module 32 and service execution module 33 execute a first service session control process for executing a first service (block B15). The procedure of this first service session control process will be described later with reference to FIG. 13.

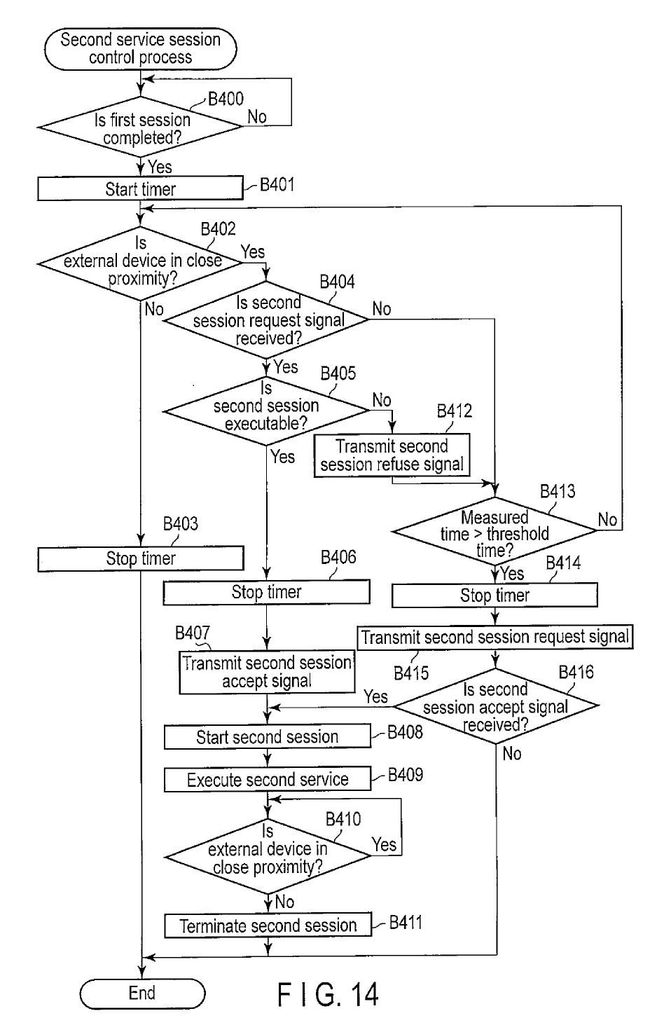

After the first service session control process has been completed, the session control module 32, service execution module 33, session monitor module 34 and timer 35 execute a second service session control process for executing a second service (block B16). The procedure of this second service session control process will be described later with reference to FIG. 14.

After the second service session control process has been completed, the connection control module 31 releases the connection between the close proximity wireless transfer device 104 and the external device 10B (block B17).

The flowchart of FIG. 12 illustrates an example of the procedure of the close proximity wireless transfer process at a time when the electronic apparatus 10A operates as a responder, a connection to which is requested by the external device 10B that is in close proximity.

To start with, the close proximity state detection module 109 determines whether a connection request signal requesting a connection has been received from the external device 10B that is in close proximity (block B21). If the connection request signal has not been received from the external device 10B (NO in block B21), the process returns to block B21, and determines once again whether a connection request signal has been received from the external device 10B. On the other hand, if the connection request signal has been received from the external device 10B (YES in block B21), the connection control module 31 transmits a connection accept signal which accepts a connection to the external device 10B via the close proximity wireless transfer device 104 (block B22). Then, the connection control module 31 establishes a connection (CNL connection) between the close proximity wireless transfer device 104 and the external device 10B (block B23).

Subsequently, the session control module 32 and service execution module 33 execute a first service session control process for executing a first service (block B24). The first service session control process is a process for executing the first service after the connection is established between the close proximity wireless transfer device 104 and the external device 10B. The procedure of this first service session control process will be described later with reference to FIG. 13.

After the first service session control process has been completed, the session control module 32, service execution module 33, session monitor module 34 and timer 35 execute a second service session control process for executing a second service (block B25). The second service session control process is a process for executing the second service after the execution of the first service has been completed. The procedure of this second service session control process will be described later with reference to FIG. 14.

After the second service session control process has been completed, the connection control module 31 releases the connection between the close proximity wireless transfer device 104 and the external device 10B (block B26).

As has been described with reference to the flowchart of FIG. 11 or FIG. 12, the electronic apparatus 10 can establish a connection by close proximity wireless transfer between itself and the external device 10B that is in close proximity, and can control the first service session and second service session.

Next, referring to a flowchart shown in FIG. 13, an example of the procedure of the first service session control process is described. The first service session control process, as described above, is a process for controlling the execution of the first service after a connection is established between the electronic apparatus 10 and the external device 10B.

To start with, the session control module 32 determines whether the start of the first service session is requested (block B301). The first service session is a service session for executing the first service. In addition, the start of the first service session is requested, for example, by the start of an application program which makes use of close proximity wireless transfer.

If the start of the first service session is requested (YES in block B301), the session control module 32 transmits to the external device 10B a first service session request signal which requests the start of the first service session (block B302). The first service session request signal includes information indicative of the first service which is to be executed in the first service session.

Then, the session control module 32 determines whether a first service session accept signal, which accepts the start of the first service session, has been received from the external device 10B (block B303). In the meantime, if the first service which is designated in the first service session request signal is an executable service, the external device 10B transmits the first service session accept signal to the electronic apparatus 10. If the first service which is designated in the first service session request signal is not an executable service, the external device 10B transmits a first service session refuse signal to the electronic apparatus 10.

When the first service session accept signal has not been received (i.e. when the first service session refuse signal which refuses the start of the first service session has been received) (NO in block B303), the session control module 32 terminates the first service session control process.

On the other hand, when the first service session accept signal has been received (YES in block B303), the session control module 32 starts the first service session (block B304). Then, the service execution module 33 executes the first service which is designated in the first service session request signal (block B305). After the execution of the first service has been completed, the session control module 32 terminates the first service session (block B306).

Meanwhile, in block B301, if the start of the first service session is not requested (NO in block B301), the session control module 32 determines whether a first service session request signal requesting the start of the first service session has been received from the external device 10B (block B307). If the first service session request signal has not been received (NO in block B307), the process returns to block B301.

On the other hand, if the first service session request signal has been received (YES in block B307), the session control module 32 determines whether the first service, which is designated in the first service session request signal, is an executable service (block B308).

If the first service is not an executable service (NO in block B308), the session control module 32 transmits to the external device 10B a first service session refuse signal which refuses the establishment of the first service session (block B310).

If the first service is an executable service (YES in block B308), the session control module 32 transmits to the external device 10B a first service session accept signal which accepts the start of the first service session (block B309), and then the session control module 32 starts the first service session (block B304). Then, the service execution module 33 executes the first service which is designated in the first service session request signal (block B305). After the execution of the first service has been completed, the session control module 32 terminates the first service session (block B306).

By the above-described process, the first service session control process is executed. In the first service session control process, when the first service is executable by both the electronic apparatus 10A and the external device 10B, the first service is successfully executed and then the process is terminated. Meanwhile, when the first service is unexecutable by either the electronic apparatus 10A or the external device 10B, the execution of the first service fails and then the process is terminated. Then, regardless of success/failure of execution of the first service, a second service session control process is executed after the termination of the first service session control process.

FIG. 14 shows an example of the procedure of the second service session control process. The second service session control process is a process for controlling the execution of the second service after the completion of execution of the first service.

To start with, the session monitor module 34 determines whether the first service session has been completed (block B400). If the first service session has not been completed (NO in block B400), the process returns to block B400 and the session monitor module 34 determines once again whether the first service session has been completed. On the other hand, if the first service session has been completed (YES in block B400), the session monitor module 34 causes the timer 35 to start measuring an elapsed time from the completion of the first service session (block B401). Then, using the close proximity state detection module 109, the session monitor module 34 determines whether the state of close proximity to the external device 10B is maintained (block B402). If the state of close proximity to the external device 10B is not maintained (NO in block B402), the session monitor module 34 causes the timer 35 to stop measuring the elapsed time (block B403), and then terminates the second service session control process.

On the other hand, if the state of close proximity to the external device 10B is maintained (YES in block B402), the session control module 32 determines whether a second service session request signal which requests the start of the second service session has been received from the external device 10B (block B404). When the second service session request signal has been received from the external device 10B (YES in block B404), the session control module 32 determines whether the second service, which is designated in the second service session request signal, is executable (block B405).

If the second service is executable (YES in block B405), the session monitor module 34 causes the timer 35 to stop measuring the elapsed time (block B406). In addition, the session control module 32 transmits to the external device 10B a second service session accept signal which accepts the start of the second service session (block B407). Then, the session control module 32 starts the second service session (block B408). The service execution module 33 executes the second service designated in the second service session request signal (block B409). While the second service is being executed, the session monitor module 34 determines, with use of the close proximity state detection module 109, whether the state of close proximity to the external device 10B is maintained (block B410). When the state of close proximity to the external device 10B is maintained (YES in block B410), the process returns to block B410. Specifically, the execution of the second service is continued. When the state of close proximity to the external device 10B is not maintained (NO in block B410), the session control module 32 terminates the second service session (block B411).

Meanwhile, if the second service is not executable (NO in block B405), the session control module 32 transmits to the external device 10B a second service session refuse signal which refuses the start of the second service session (block B412). Then, the session monitor module 34 determines whether the elapsed time measured by the timer 35 exceeds a threshold time (block B413). In addition, if the second service session request signal has not been received from the external device 10B (NO in block B404), the session monitor module 34 determines whether the elapsed time measured by the timer 35 exceeds a threshold time (block B413).

If the elapsed time measured by the timer 35 does not exceed the threshold time (NO in block B413), the process returns to block B402.

On the other hand, if the elapsed time measured by the timer 35 exceeds the threshold time (YES in block B413), the session monitor module 34 causes the timer 35 to stop measuring the elapsed time (block B414). Then, the session control module 32 transmits to the external device 10B a second service session request signal which requests the start of the second service session (block B415).

Subsequently, the session control module 32 determines whether a second service session accept signal which accepts the start of the second service session has been received from the external device 10B (block B416). If the second service session accept signal has not been received from the external device 10B (i.e. if a second service session refuse signal which refuses the start of the second service session has been received) (NO in block B416), the session control module 32 terminates the second service session control process.

On the other hand, if the second service session accept signal has been received from the external device 10B (YES in block B416), the session control module 32 starts the second service session (block B408). Then, the service execution module 33 executes the second service designated in the second service session request signal (block B409). While the second service is being executed, the session control module 32 determines, with use of the close proximity state detection module 109, whether the state of close proximity to the external device 10B is maintained (block B410). When the state of close proximity to the external device 10B is maintained (YES in block B410), the process returns to block B410. Specifically, the execution of the second service is continued. When the state of close proximity to the external device 10B is not maintained (NO in block B410), the session control module 32 terminates the second service session (block B411).

By the above-described process, the second service session control process is executed. In the second service session control process, when the close proximity state between the electronic apparatus 10A and the external device 10B is maintained for more than the threshold time after the termination of the first service session, the start of the second service session is attempted. If the second service is executable by both the electronic apparatus 10A and the external device 10B, the second service is executed. Thereby, the fact that the electronic apparatus 10A and the external device 10B are left in close proximity after the completion of execution of the first service is regarded as one of actions (operations) by the user, and is used as a trigger to start the second service. Accordingly, simply by performing only once the touch operation of bringing the electronic apparatus 10A and external device 10B in close proximity, the user can execute the two services. Therefore, the convenience for the user can be enhanced.

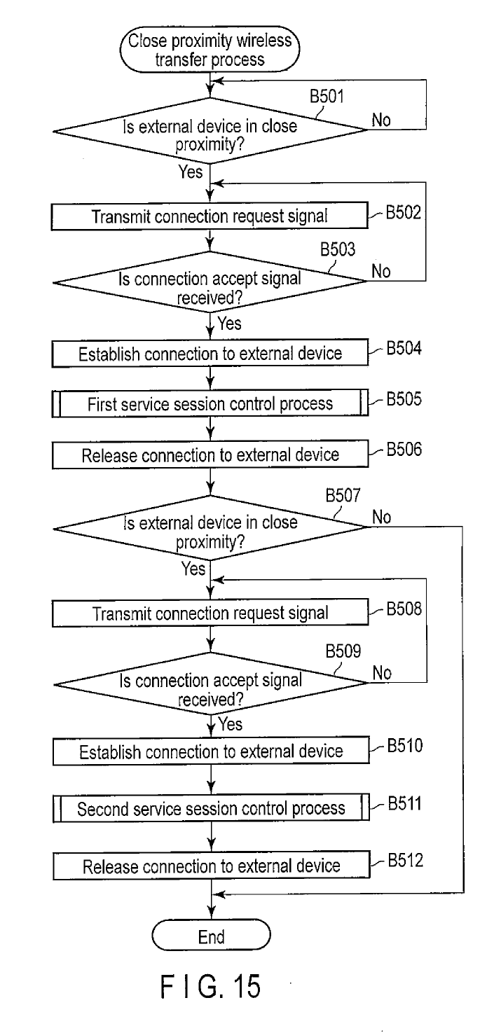

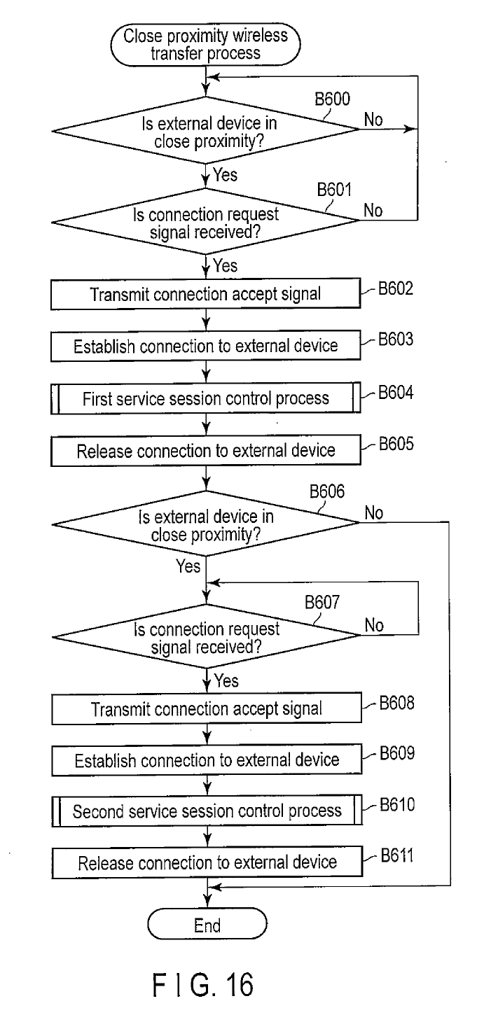

FIGS. 15 and 16 illustrate other examples of the procedure of the close proximity wireless transfer process which is executed by the electronic apparatus 10. In the examples illustrated in FIGS. 15 and 16, it is assumed that the connection (CNL connection) is released after the termination of the session.

The flowchart of FIG. 15 illustrates an example of the procedure of the close proximity wireless transfer process at a time when the electronic apparatus 10A operates as an initiator which requests a connection to the external device 10B that is in close proximity.

To start with, the close proximity state detection module 109 determines whether the external device 10B is in close proximity (block B501). If the external device 10B is not in close proximity (NO in block B501), the process returns to block B501, and determines once again whether the external device 10B is in close proximity. On the other hand, if the external device 10B is in close proximity (YES in block B501), the connection control module 31 transmits a connection request signal for requesting a connection to the external device 10B via the close proximity wireless transfer device 104 (block B502).

Then, the connection control module 31 determines whether a connection accept signal which accepts a connection has been received from the external device 10B via the close proximity wireless transfer device 104 (block B503). If the connection accept signal has not been received (e.g. if a connection refuse signal which refuses a connection has been received, or if a connection accept signal has not been received even after the passing of a predetermined period) (NO in block B503), the process returns to block B502, and the connection control module 31 transmits the connection request signal once again. When a connection accept signal is not received even if the connection request signal has been transmitted a predetermined number of times, the process may be terminated.

On the other hand, if the connection accept signal has been received (YES in block B503), the connection control module 31 establishes a connection (CNL connection) between the close proximity wireless transfer device 104 and the external device 10B (block B504). Then, the session control module 32 and service execution module 33 execute a first service session control process for executing a first service (block B505). The procedure of this first service session control process has been described above with reference to FIG. 13. After the first service session control process has been completed, the connection control module 31 releases the connection between the close proximity wireless transfer device 104 and the external device 10B (block B506).

After the connection to the external device 10B has been released, the close proximity state detection module 109 determines whether the external device 10B is in close proximity (block B507). When the external device 10B is not in close proximity (NO in block B507), the close proximity wireless transfer process is terminated.

On the other hand, when the external device 10B is in close proximity (YES in block B507), the connection control module 31 transmits a connection request signal for requesting a connection to the external device 10B via the close proximity wireless transfer device 104 (block B508). Then, the connection control module 31 determines whether a connection accept signal which accepts a connection has been received from the external device 10B via the close proximity wireless transfer device 104 (block B509). If the connection accept signal has not been received (e.g. if a connection refuse signal which refuses a connection has been received, or if a connection accept signal has not received even after the passing of a predetermined period) (NO in block B509), the process returns to block B508, and the connection control module 31 transmits the connection request signal once again. When a connection accept signal is not received even if the connection request signal has been transmitted a predetermined number of times, the process may be terminated.

On the other hand, if the connection accept signal has been received (YES in block B509), the connection control module 31 establishes a connection (CNL connection) between the close proximity wireless transfer device 104 and the external device 10B (block B510). Then, the session control module 32, service execution module 33, session monitor module 34 and timer 35 execute a second service session control process for executing a second service (block B511). The procedure of this second service session control process has been described above with reference to FIG. 14. After the second service session control process has been completed (e.g. when the close proximity state between the close proximity wireless transfer device 104 and the external device 10B has been released), the connection control module 31 releases the connection between the close proximity wireless transfer device 104 and the external device 10B (block B512).

The flowchart of FIG. 16 illustrates an example of the procedure of the close proximity wireless transfer process at a time when the electronic apparatus 10A operates as a responder, a connection to which is requested by the external device 10B that is in close proximity.

To start with, the close proximity state detection module 109 determines whether the external device 10B is in close proximity (block B600). When the external device 10B is not in close proximity (NO in block B600), the process returns to block B600, and determines once again whether the external device 10B is in close proximity. On the other hand, when the external device 10B is in close proximity (YES in block B600), the connection control module 31 determines whether a connection request signal requesting a connection has been received the external device 10B that is in close proximity (block B601). If the connection request signal has not been received from the external device 10B (NO in block B601), the process returns to block B601, and determines once again whether a connection request signal has been received from the external device 10B. On the other hand, if the connection request signal has been received from the external device 10B (YES in block B601), the connection control module 31 transmits a connection accept signal which accepts a connection to the external device 10B via the close proximity wireless transfer device 104 (block B602). Then, the connection control module 31 establishes a connection (CNL connection) between the close proximity wireless transfer device 104 and the external device 10B (block B603).

Subsequently, the session control module 32 and service execution module 33 execute a first service session control process for executing a first service (block B604). The first service session control process is a process for executing the first service after the connection is established between the close proximity wireless transfer device 104 and the external device 10B. The procedure of this first service session control process has been described above with reference to FIG. 13. After the first service session control process has been completed, the connection control module 31 releases the connection between the close proximity wireless transfer device 104 and the external device 10B (block B605).

After the connection to the external device 10B has been released, the close proximity state detection module 109 determines whether the external device 10B is in close proximity (block B606). When the external device 10B is not in close proximity (NO in block B606), the close proximity wireless transfer process is terminated.

On the other hand, when the external device 10B is in close proximity (YES in block B606), the connection control module 31 determines whether a connection request signal requesting a connection has been received from the external device 10B that is in close proximity (block B607). If the connection request signal has not been received from the external device 10B (NO in block B607), the process returns to block B607, and determines once again whether a connection request signal has been received from the external device 10B. On the other hand, if the connection request signal has been received from the external device 10B (YES in block B607), the connection control module 31 transmits a connection accept signal which accepts a connection to the external device 10B via the close proximity wireless transfer device 104 (block B608). Then, the connection control module 31 establishes a connection between the close proximity wireless transfer device 104 and the external device 10B (block B609).

After the connection to the external device 10B has been established, the session control module 32, service execution module 33, session monitor module 34 and timer 35 execute a second service session control process for executing a second service (block B610). The second service session control process is a process for executing the second service after the completion of execution of the first service. The procedure of this second service session control process has been described above with reference to FIG. 14.

After the second service session control process has been completed, the connection control module 31 releases the connection between the close proximity wireless transfer device 104 and the external device 10B (block B611).

As has been described above with reference to the flowchart of FIG. 15 or FIG. 16, the electronic apparatus 10A can establish a connection by close proximity wireless transfer between itself and the external device 10B that is in close proximity, and can control the execution of the first service and the second service.

According to the present embodiment, as described above, the two devices which are left in close proximity can be effectively used. Such control can be executed that the second service session is started when the close proximity state between the electronic apparatus 10 (close proximity wireless transfer device 104) and the external device is maintained for more than the threshold time after the termination of the first service session. Thereby, when the electronic apparatus 10 and the external device are left in close proximity after the termination of the first service, the fact that the electronic apparatus 10 and the external device are left in close proximity can be regarded as an action (operation) by the user, and a transition can be made to the constant-type (always-on type) second service. Therefore, the convenience for the user can be enhanced.

All the procedures of the close proximity wireless transfer process in this embodiment may be executed by software. Thus, the same advantageous effects as with the present embodiment can easily be obtained simply by installing a computer program, which executes the procedures of the close proximity wireless transfer process, into an ordinary computer through a computer-readable storage medium, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a communication module configured to execute close proximity wireless transfer;
a close proximity state detector configured to detect that the communication module and an external device configured to execute close proximity wireless transfer are in a close proximity state;
a connection establishing module configured to establish a connection between the communication module and the external device when the close proximity state has been detected; and
a session controller configured to execute a first service when the connection has been established, and to execute a second service when a first threshold time has passed while the close proximity state is maintained after completion of the execution of the first service.

2. The electronic apparatus of claim 1, wherein the session controller is configured to transmit a first service session request signal to the external device when the connection has been established, and to establish a first service session and execute the first service when a first service session accept signal has been received from the external device, the first service session request signal being for executing the first service, and the first service session accept signal being for accepting the execution of the first service.

3. The electronic apparatus of claim 2, wherein the session controller is configured
to transmit a second service session request signal to the external device when the first threshold time has passed while the close proximity state is maintained after the completion of the execution of the first service, and
to establish a second service session and execute the second service when a second service session accept signal has been received from the external device,
the second service session request signal being for executing the second service, and the second service session accept signal for accepting the execution of the second service.

4. The electronic apparatus of claim 2, wherein the session controller is configured
to receive a second service session request signal from the external device when the first threshold time has passed while the close proximity state is maintained after the completion of the execution of the first service, and
to establish a second service session and execute the second service when a second service session accept signal has been transmitted to the external device,
the second service session request signal being for executing the second service, and the second service session accept signal being for accepting the execution of the second service.

5. The electronic apparatus of claim 2, wherein the session controller is configured
to transmit a second service session request signal to the external device when the first threshold time has passed while the close proximity state is maintained after the completion of the execution of the first service,
to receive a second service session refuse signal from the external device,
to receive a second service session request signal from the external device when a second threshold time that is longer than the first threshold time has passed while the close proximity state is maintained after the completion of the execution of the first service, and
to establish a second service session and execute the second service when a second service session accept signal has been transmitted to the external device,
the second service session request signal being for executing the second service, the second service session refuse signal being for refusing the execution of the second service, and the second service session accept signal being for accepting the execution of the second service.

6. The electronic apparatus of claim 1, wherein the session controller is configured
to receive a first service session request signal from the external device when the connection has been established, and
to establish a first service session and execute the first service when a first service session accept signal has been transmitted to the external device,
the first service session request signal being for executing the first service, and the first service session accept signal being for accepting the execution of the first service.

7. The electronic apparatus of claim 6, wherein the session controller is configured
to transmit a second service session request signal to the external device when the first threshold time has passed while the close proximity state is maintained after the completion of the execution of the first service, and
to establish a second service session and execute the second service when a second service session accept signal has been received from the external device,
the second service session request signal being for executing the second service, and the second service session accept signal for accepting the execution of the second service.

8. The electronic apparatus of claim 6, wherein the session controller is configured
to receive a second service session request signal from the external device when the first threshold time has passed while the close proximity state is maintained after the completion of the execution of the first service, and
to establish a second service session and execute the second service when a second service session accept signal has been transmitted to the external device,
the second service session request signal being for executing the second service, and the second service session accept signal being for accepting the execution of the second service.

9. The electronic apparatus of claim 6, wherein the session controller is configured
to transmit a second service session request signal to the external device when the first threshold time has passed while the close proximity state is maintained after the completion of the execution of the first service,
to receive a second service session refuse signal from the external device,
to receive a second service session request signal from the external device when a second threshold time that is longer than the first threshold time has passed while the close proximity state is maintained after the completion of the execution of the first service, and
to establish a second service session and execute the second service when a second service session accept signal has been transmitted to the external device,
the second service session request signal being for executing the second service, the second service session refuse signal being for refusing the execution of the second service, and the second service session accept signal being for accepting the execution of the second service.

10. The electronic apparatus of claim 1, wherein the session controller is configured to execute the second service when the first threshold time has passed while the connection is established after the completion of the execution of the first service.

11. The electronic apparatus of claim 1, further comprising a timer configured to measure an elapsed time from the completion of the execution of the first service,
wherein the session controller is configured to execute the second service when the elapsed time measured by the timer has exceeded the first threshold time.

12. The electronic apparatus of claim 11, wherein the close proximity state detector is configured to further detect that the close proximity state has been released,
wherein the timer is configured to stop measuring the elapsed time, when the close proximity state detector has detected that the close proximity state has been released, when the connection has been released, or when the execution of the second service has been started.

13. The electronic apparatus of claim 1, wherein the second service is terminated in response to a release of the close proximity state.

14. The electronic apparatus of claim 1, wherein the close proximity state detector is configured to detect the close proximity state in which the external device is within a predetermined distance from the communication module.

15. A communication control method of controlling close proximity wireless transfer by a communication module, the method comprising:
detecting that the communication module and an external device are in a close proximity state;
establishing a connection between the communication module and the external device when the close proximity state has been detected; and
executing a first service when the connection has been established, and executing a second service when a first threshold time has passed while the close proximity state is maintained after completion of the execution of the first service.
